(19) United States
(12) Patent Application Publication
(10) Pub. No.: US 2006/0139683 A1
(43) Pub. Date: Jun. 29, 2006

(54) Print job processing system, output device, program, and storage medium

(75) Inventor: Toyoaki Oku, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KYOCERA MITA CORPORATION, Osaka (JP)

(21) Appl. No.: 11/305,222

(22) Filed: Dec. 19, 2005

(30) Foreign Application Priority Data
Dec. 28, 2004 (JP) 2004-378590

(51) Int. Cl. G06F 3/12

(52) U.S. Cl. 358/1.15

(57) ABSTRACT

The present invention relates to a print job processing system, an output device, and a print job processing method which ensures security by allowing only intended users to print a stored print job. The print job processing system comprises a folder 31 consisting of multiple folders provided for a printer 3, and to which various information PA, . . . , PN outputted by several persons are respectively independently registered, an external storage device 4 which receives a supply of print jobs from the host computer 2 of the storing person, and stores the print jobs associated with the storage folders for specified information Q generated by the host computer for the storing person, a processing circuit 32 which stores the storage folders for specified information Q in predetermined folders of the folder 31, and notifies the respective host computers for the outputting persons 5A, . . . , 5N of the storage of the storage folders for specified information Q outputted by the relevant outputting person 8, and an output section 33 which reads and prints out the print job stored in the external storage device 4 based on the storage folders for specified information by the host computer for the outputting person

### BACKGROUND OF THE INVENTION

1. Field of the Invention

The present invention relates to a print job processing system for supplying an output device with a print job from a host computer used by a storing person in order to print out the print job, the output device, a program, and a storage medium, and more particularly, to a print job processing system, an output device, a program, and a storage medium where a print job is outputted only by outputting persons specified by the storing person.

2. Description of the Prior Art

Conventionally, as described in Japanese Laid-Open. Patent Publication No. 2003-44236 (paragraphs [0013], [0144], and [0148] to [0150]), for example, in an environment where multiple users share a page printer intended for a network, a stored job may be printed by other users. In such an environment, if a particular user intends to notify other users of an update made to a stored job, it is difficult for him to determine the user or users who have already outputted the stored job. To ensure that no one is omitted, it is necessary to notify all users who possibly share the page printer, which is rather inconvenient for the user who must make the notification, as the updating and notifying process becomes complex, since users who do not require notification are likewise notified. A solution to this problem has been proposed in Japanese Laid-Open Patent Publication No. 2003-44236, wherein a user who has updated a stored job and wishes to notify other users of the update creates a list of users who have outputted the stored job, and notifies the respective users in the said list of the update. The method of carrying out this notification is similar to that of electronic mail.

However, according to the technique proposed in the abovementioned published patent application, any of the users can freely print a stored job, and security protection is not particularly ensured, because even if the entry of a password is necessary to gain access to the system, strict confidentiality cannot be maintained because it is necessary to notify all users of the password to enable them to print a stored job.

### SUMMARY OF THE INVENTION

The present invention has therefore been devised to address the foregoing problem by providing a print job processing system, an output device, a program, and a storage medium, which provide confidentiality protection by permitting only intended users to print a stored job.

The print job processing system according to the first aspect of the present invention comprises an output device for carrying out print jobs from a host computer used by a storing person, which includes:

folder means consisting of multiple folders provided for the output device, and to which various kinds of information outputted by a number of outputting persons are respectively independently registered;

external storage means that receives and stores the supply of print jobs in the corresponding storage folder for specified information generated by the host computer used by the storing person;

processing means that stores the storage folder for specified information in predetermined folders of the folder means, and notifies the host computer used by the outputting person of such storage; and

output means that reads and prints out the print job stored in the external storage means based on the storage folder for specified information stored in the predetermined folders by the host computer used by the outputting person.

The output device that receives print jobs transmitted from a host computer used by a storing person according to the second aspect of the present invention comprises:

folder means consisting of multiple folders to which various kinds of information outputted by a number of outputting persons are respectively independently registered;

storage means that stores print jobs transmitted from the host computer used by the storing person corresponding to the storage folder for specified information;

processing means that stores the storage folder for specified information in predetermined folders of the folder means, and notifies host computers used by outputting persons of the storage of the storage folder for specified information; and

output means that reads and prints out the print jobs stored in the storage means upon receipt of an instruction from the host computers used by the outputting persons based on the storage folder for specified information.

A program for causing a computer equipped with a print job processing system that supplies an output device with print jobs stored in a host computer used by a storing person in order to carry out the print jobs, according to the third aspect of the present invention, comprises:

a process for independently registering various kinds of information outputted by a number of outputting persons in respective folders;

a process for generating print jobs and establishing storage folders for specified information which specifies the outputting persons to the host computer used by the storing person;

a process for storing the print job associated with the storage folder for specified information in an external storage device;

a process for storing the storage folder for specified information in folders corresponding to the predetermined outputting persons, and notifying the latter of such storage; and

a process for reading and outputting the print jobs stored in the external storage device based on the storage folder for specified information by means of the host computers used by the outputting person or persons. [add]

The storage medium according to the fourth aspect of the present invention stores the program according to the third aspect of the present invention.

### BRIEF DESCRIPTION OF THE DRAWINGS

FIG. 1 is a block diagram showing a print job processing system according to the first embodiment of the present invention;

FIG. 2 is a diagram showing the interaction between a storing person and an outputting person by means of folders in FIG. 1;

FIG. 3 is a flowchart showing the first method of initial setting according to the embodiment of the present invention;

FIG. 4 is a flowchart showing the second method of initial setting according to the embodiment of the present invention;

FIG. 5 is a flowchart showing the process of storing a print job according to the embodiment of the present invention; and

FIG. 6 is a flowchart showing the process of carrying out the print job according to the embodiment of the present invention.

### DETAILED DESCRIPTION OF THE PREFERRED EMBODIMENTS

A detailed description will now be given of a specific example of the present invention with reference to the embodiment and drawings.

### Embodiment

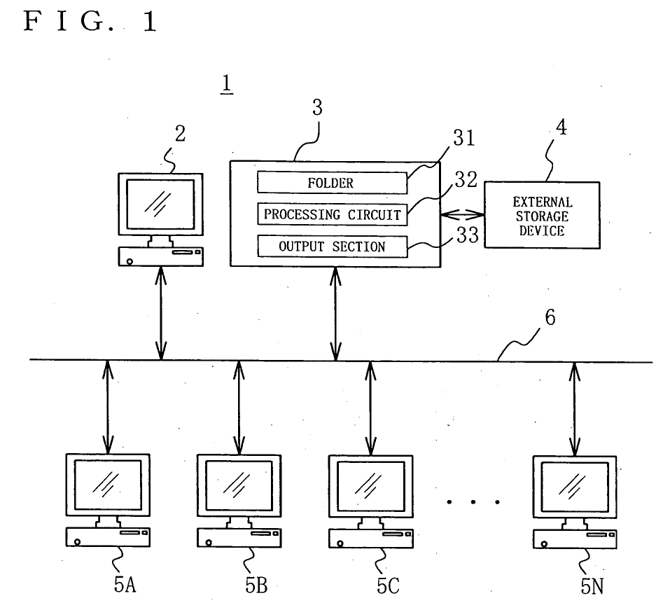

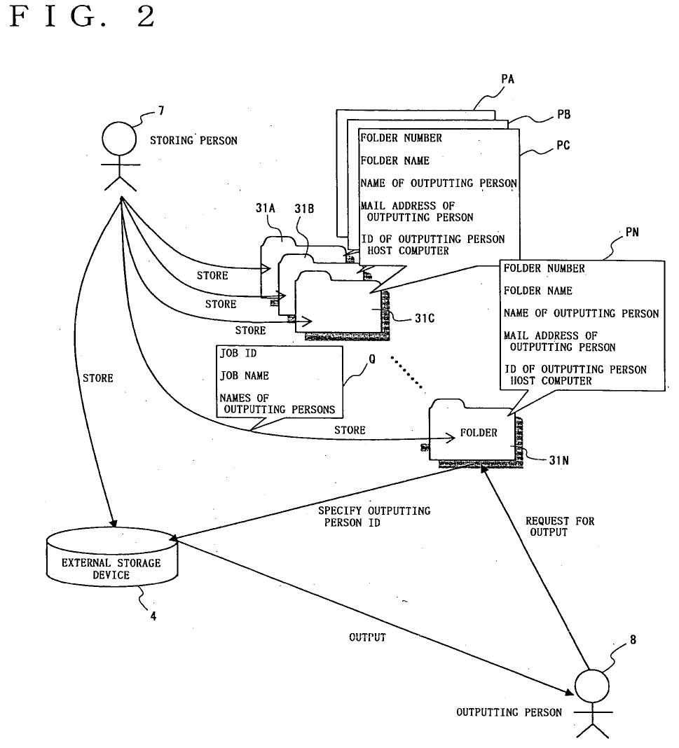

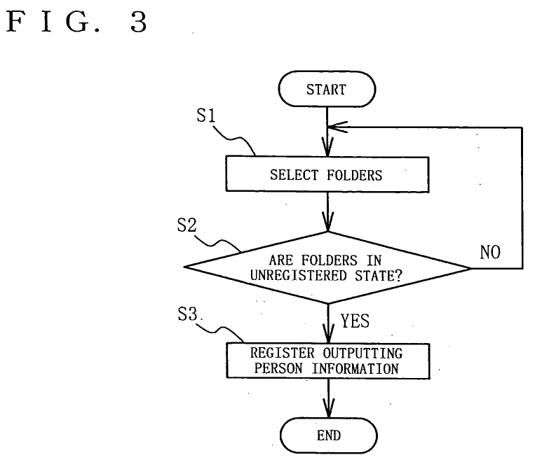

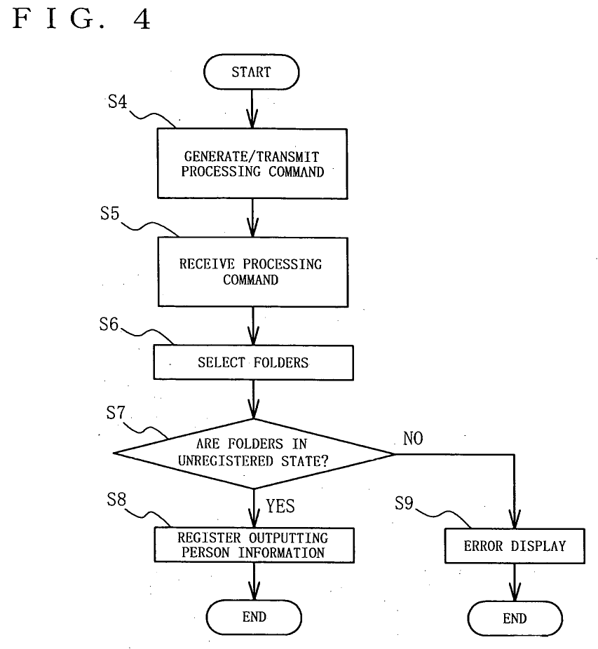

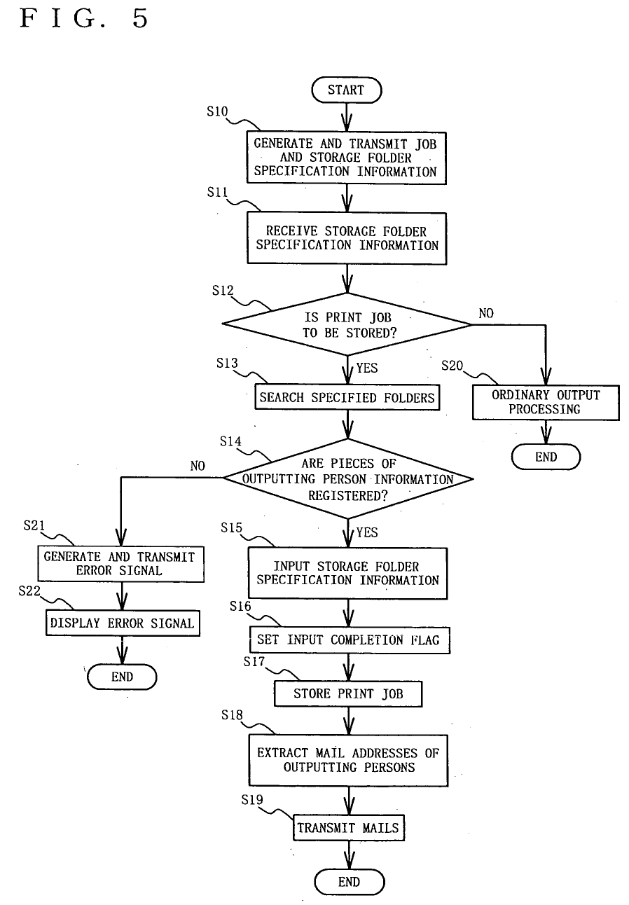

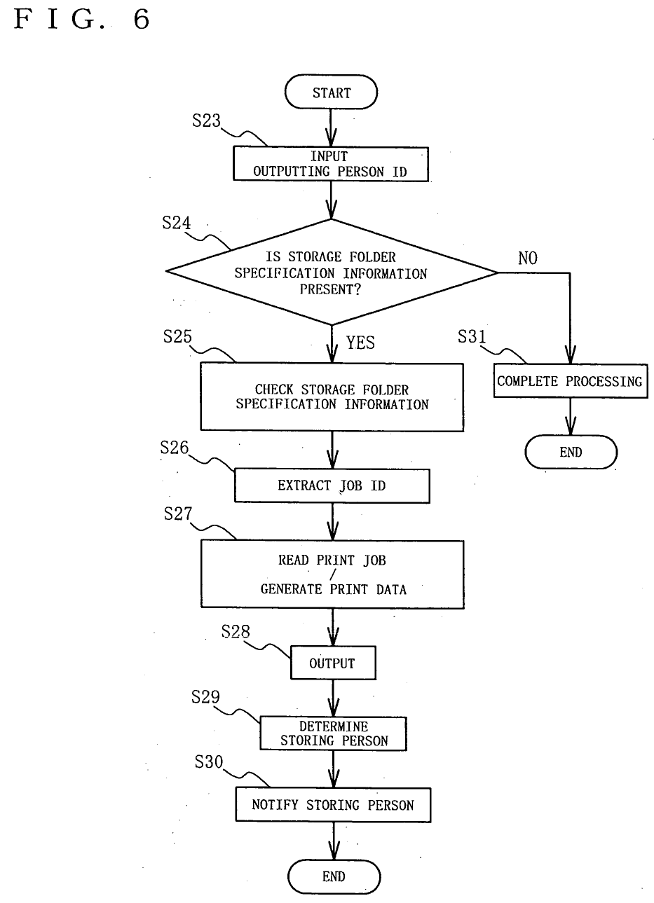

A description will be given of the embodiment of the present invention with reference to FIGS. 1 to 6. FIG. 1 is a block diagram showing a print job processing system according to the first embodiment of the present invention, while FIG. 2 is a diagram showing the interaction between a storing person and an outputting person by means of folders in FIG. 1, and FIG. 3 is a flowchart showing the first method of initial setting according to the embodiment of the present invention. FIG. 4 is a flowchart showing the second method of initial setting according to the embodiment of the present invention, while FIG. 5 is a flowchart showing the process of storing a print job according to the embodiment of the present invention and FIG. 6 is a flowchart showing the process of carrying out the print job according to the embodiment of the present invention.

In FIG. 1, the print job processing system 1 comprises a host computer 2 for the storing person, a printer 3, an external storage device 4, and corresponding host computers for outputting persons 5A, 5B, 5C, . . . , and 5N, and is formed by connecting the host computer 2 of the storing person, the printer 3, the external storage device 4, and the corresponding host computers for outputting persons 5A, 5B, 5C, . . . , and 5N over a network 6. The printer 3 includes a folder 31, a processing circuit 32, and an output section 33.

Folders 31A, 31B, 31C, . . . , and 31N corresponding to such number of outputting persons for carrying out print jobs are provided in folder 31 as shown in FIG. 2. The various bits of information PA, PB, PC, . . . , and PN respectively outputted by the different outputting persons are independently registered in the folders 31A, 31B, 31C, . . . , and 31N respectively dedicated to the outputting persons. These pieces of outputted information PA, PB, PC, . . . , and PN include the assigned number and name of the folder, the name and mail address of the outputting person, and the ID of the host computer used by the outputting person. Each of the folders 31A, 31B, 31C, . . . , and 31N are respectively assigned a number for purposes of identification.

A storing person 7 transmits a print job created by the host computer 2 to the external storage device 4, which records and stores the print job. At the same time, the storing person 7 creates a storage folder for specified information Q which specifies the outputting person or persons to the storing person host computer 2. The storage folder for specified information Q includes pieces of information such as job ID, job name, and the names of the outputting persons. The storage folder for specified information Q is stored in the folders 31A, 31B, 31C, . . . , and 31N corresponding to predetermined outputting persons who have been specified. For example, if the folder 31N is selected from the folders 31A, 31B, 31C, . . . , and 31N, the storing person specifies the outputting person who will carry out or output the print job by selecting a predetermined outputting person 8, who is then notified of the existence of the stored print job.

The predetermined outputting person 8 who has received the notice then searches and requests the folders 31A, 31B, 31C, . . . , and 31N for the output. Once it is confirmed that the storage folder for specified information Q stored in this folder 31N corresponds to the outputting person 8, the print job stored in the external storage device 4 is outputted by the output section 33 according to the predetermined job ID obtained from the folder 31. This processing is carried out by the processing circuit 32.

According to the print job processing system 1 configured in the above-described manner, it is necessary for the storing person to initially set dedicated folders for the respective outputting persons as the folders 31A, 31B, 31C, . . . , and 31N. There are two methods of performing the initial setting.

In the first method, setting is carried out on the operation panel (not shown) of the printer 3. The storing person who is aware of the respective folder numbers for each of the folders 31A, 31B, 31C, . . . , and 31N, registers the various pieces of information PA, PB, PC, . . . , and PN outputted by means of the operation panel of the printer 3, by establishing dedicated folders corresponding to each of the outputting persons. Specifically, as shown in FIG. 3, in step S1, the storing person selects folders by specifying folder numbers used to register the pieces of information PA, PB, PC, . . . , and PN outputted by means of the operation panel. In step S2, it is determined whether the selected folders have been registered and whether the various bits of information PA, PB, PC, . . . , and PN have been registered to the pre-selected folders. If the selected folders have not been registered, the outputted information PA, PB, PC, . . . , and PN are then registered to the selected folders in step S3. On the other hand, if the selected folders are determined to have been registered in step 2, the process of selection by designating different folder numbers is repeated. In this way, the multiple pieces of outputted information PA, PB, PC, . . . , and PN outputted by the various outputting persons are respectively independently registered to the folders 31A, 31B, 31C, . . . , and 31N.

In the second method, setting is carried out from the host computer 2 of the storing person via the network 6. Specifically, as shown in FIG. 4, in the host computer 2, the storing person initially creates a command for processing including the pieces of the outputted information PA, PB, PC, . . . , and PN, such as folder numbers and mail addresses of the outputting persons, and then transmits the processing command to the printer 3 in step S4. In step S5, the printer 3 receives the processing command and folders are then selected according to the folder numbers indicated in the received processing command in step S6. In step S7, determination is made whether the selected folders have been previously registered. If not, the pieces of outputted information PA, PB, PC, . . . , and PN are respectively registered to the selected folders in step S8. On the other hand, if the selected folders were in fact previously registered as determined in step S7, an error signal will appear on the monitor of the host computer 2 used by the storing person by virtue of step S9. The storing person 7 thus repeats the process of selection using different folder numbers.

It should be noted that the outputting persons may respectively register the pieces of outputted information PA, PB, PC, . . . , and PN to the folders 31A, 31B, 31C, . . . , and 31N.

As shown in FIG. 5, in order to store a print job, the storing person 7 specifies and stores folders for and designates the outputting persons 8 who will carry out a print job. Specifically, the storing person 7 initially creates a storage folder for specified information Q along with a print job in the host computer 2 of the storing person by means of step S10. The print job and the storage folder for specified information Q are transmitted from the host computer 2 of the storing person to the printer 3 in step S11. In step S12, determination is made in the printer 3 whether the print job is to be stored or not in accordance with the storage folder for specified information Q. If it is determined that the print job shall be stored, specific folders are searched based on the existing folder IDs in the succeeding step S13. Thereafter, determination is made whether the pieces of outputted information PA, PB, PC, . . . , and PN have been registered to the specified folders by virtue of step S14. If the resulting determination is positive, the storage folder for specific information Q is inputted to the folder 31N, for example, in step S15, and upon completion of input, a corresponding input completion flag is set in the succeeding step S16. The print job along with the job ID is transmitted to and stored in the external storage device 4 by virtue of step S17. In other words, the print job associated with the storage folder for specified information Q is stored in the external storage device 4.

In addition, after completion of storage of the print job in step S17, the corresponding mail addresses of the outputting persons 8 are extracted by means of step S18 for purposes of confirmation based on the pieces of outputted information PA, PB, PC, . . . , and PN. Notices that the print job has been stored in the external storage device 4 are then transmitted to the outputting persons 8 by means of electronic mail based on their mail addresses in step S19. The notices include the names of the storing persons as well as the title of the stored print job.

Further, in step S12, if determination has been made that the print job is not to be outputted by predetermined outputting persons 8, the print job is processed as an ordinary output by means of step S20. In other words, although it is stored in the external storage device 4, the print job is stored in such condition as would permit any outputting person to output it freely.

Further, in step S14, if determination has been made that the pieces of outputted information PA, PB, PC, . . . , or PN have not been registered, an error signal is generated and transmitted to the host computer 2 of the storing person by virtue of step S21, which error signal is displayed on the monitor of the host computer 2 by means of step S22.

Description will now be given of the process of outputting a print job by an outputting person 8 where the print job is stored in the external storage device 4 by the outputting person 8 himself, with reference to a flowchart shown in FIG. 6.

The outputting person 8 is notified by mail addressed to the outputting person 8 of the presence of a print job to be outputted. The outputting person 8 selects the corresponding folder based on the notice, and inputs a specific outputting person ID by means of step S23. The outputting person 8 searches a selected folder 31N, for example, and determines whether a storage folder for specified information Q exists corresponding to the print job in the succeeding step S24. If determination has been made that it exists, the contents of the folder are then checked by virtue of step S25. In step S26, the corresponding job ID is extracted and the output section 33 reads out the print job corresponding to the job ID from the external storage device 4, and generates print data in the succeeding step S27. The print data is then printed and outputted by the printer 3 by means of step S28. After outputting is completed, the storing person 7 is identified in step S29, and the storing person 7 is thus notified that the print job has been outputted by the outputting person 8 by virtue of step S30. The storing person 7 can thus verify whether the output made by the outputting person 8 whom the storing person 7 designated has been completed based on this notice.

In step S24, if determination has been made that the storage folder for specified information Q does not exist, the print job is processed on the assumption that the output processing has been completed, by means of step S31.

As described above, according to the embodiment of the present invention, by means of the pieces of outputted information PA, PB, PC, . . . , and PN, the storing person 7 can register data regarding the respective outputting persons to the folders 31A, 31B, 31C, . . . , and 31N and can store the storage folder for specified information Q, which is generated by the host computer 2 of the storing person, and which specifies predetermined outputting persons 8 registered in advance, in folders corresponding to the predetermined outputting persons 8, by means of the processing circuit 32. When the storing person 7 transmits to and stores the print job in the external storage device 4, the processing circuit 32 notifies the predetermined outputting persons 8 of such transmission. The predetermined outputting persons 8 cause the output section 33 to search the folders which hold the storage job specification information Q, and to read and carry out the print job from the external storage device 4 based on the storage job specification information Q. The storing person 7 can select and specify that the print job shall be outputted only by the predetermined outputting persons 8, thereby providing the desired security protection. On the other hand, if it is not necessary to provide such security protection, the storing person 7 can store a particular print job in the external storage device 4 without requiring a storage folder for specified information Q. As a result, any of the outputting persons 8 can freely read and carry out the print job from the external storage device 4 without being specified.

While the host computer 2 of the storing person specifies predetermined outputting persons and transmits the print job according to the embodiment of the present invention, the invention is not limited to such configuration, as the corresponding host computers of the outputting persons 5A, 5B, 5C, . . . , and 5N may predetermine the outputting persons and store the particular print job in the external storage device 4. Stated otherwise, such outputting persons corresponding to the host computers 5A, 5B, 5C, . . . , and 5N may also act as storing persons.

Moreover, although the embodiment of the present invention refers to one outputting person, the present invention is not limited to this configuration, as several outputting persons may be selected to store storage folders with specified information Q in multiple folders and provide the output desired with security.

Further, while the embodiment of the present invention refers to a single printer 3 for carrying out print jobs, the invention is not limited to such configuration as the printer 3 may be integrated into other devices such as the print function of a multifunctional device capable of performing the functions of a printer, a facsimile, and the like.

Further still, although the external storage device 4 is provided independently of the printer 3 according to the embodiment of the present invention, the invention is not limited to such configuration as the external storage device 4 may also be integrated along with the printer 3 into a multifunction device, by way of example.

According to the first aspect of the present invention, the processing means stores the storage folders for specified information which are generated by the host computer used by the storing person, and which specify the predetermined outputting persons, in folders which correspond to the predetermined outputting persons and are registered in advance by the folder means, and notifies the predetermined outputting persons of the print job having been transmitted. On the other hand, the print job is associated with a storage folder for specific information, and is stored in the external storage means. The predetermined outputting persons then cause the output means to read and output the print job from the external storage means based on the storage job specified information. Since the print job is outputted only by predetermined outputting persons, the storing person can provide the desired security. In addition, since the outputting persons who may output the print job can be pre-selected and specified from a number of outputting persons, it is possible to change the outputting persons easily according to the contents of the print job. Further, since the outputting persons are notified of its transmission to them, they are not likely to overlook the print job and can therefore promptly output the same from the output device. Further still, this print job processing system provides a cost advantage since it can be set up by adding the folder means and the processing means to the shared output device, without imposing any additional requirements or changes in the various host computers.

According to the second aspect of the present invention, the processing means stores the storage folders for specified information which are generated by the host computer used by the storing person, and which specify the predetermined outputting persons, in folders which correspond to the predetermined outputting persons and are registered in advance by the folder means, and notifies the predetermined outputting persons of the print job having been transmitted. On the other hand, the print job is associated with a storage folder for specific information, and is stored in the storage means. The predetermined outputting persons then cause the output means to read and output the print job from the storage means based on the storage job specified information. Since the print job is outputted only by predetermined outputting persons, the storing person can provide the desired security. In addition, since the outputting persons who may output the print job can be pre-selected and specified from a number of outputting persons, it is possible to change the outputting persons easily according to the contents of the print job. Further, since the outputting persons are notified of its transmission to them, they are not likely to overlook the print job and can therefore promptly output the same from the output device.

According to the third and fourth aspects of the present invention, when the multiple pieces of information outputted by various outputting persons are respectively independently registered to the folders, the storing person generates the print job, stores the print job in the storage device, and stores the storage folder for specific information that specifies predetermined outputting persons in the corresponding folders, and notifies the predetermined outputting persons of such storage. The predetermined outputting persons then read and output the print job from the storage device based on the storage job specified information. Since the print job is output by means of printing only carried out by predetermined outputting persons, the storing person can provide the desired security. In addition, since the outputting persons who may output the print job can be pre-selected and specified from a number of outputting persons, it is possible to change the outputting persons easily according to the contents of the print job. Further, since the outputting persons are notified of its transmission to them, they are not likely to overlook the print job and can therefore promptly output the same from the output device.

What is claimed is:

1. A print job processing system that supplies an output device with a print job stored in a host computer used by the storing person in order to carry out the print job, comprising:
folder means consisting of a plurality of folders provided for the output device, and to which various kinds of information outputted by a number of outputting persons are respectively independently registered;
external storage means that receives and stores the supply of print jobs in the corresponding storage folders for specified information generated by the host computer used by the storing person;
processing means that stores the said storage folders for specified information in predetermined folders of the said folder means, and notifies the host computer used by the outputting person of the storage of the said storage folders for specified information; and
output means that reads and prints out the print job stored in the said external storage means based on the storage folders for specified information stored in the predetermined folders by the host computer used by the outputting person.

2. An output device that receives a print job transmitted from a host computer used by the storing person, comprising:
folder means consisting of a plurality of folders provided for the output device, and to which various kinds of information outputted by a number of outputting persons are respectively independently registered;
storage means that stores print jobs transmitted from the host computer used by the storing person corresponding to the storage folders for specified information;
processing means that stores the storage folders for specified information in predetermined folders of the said folder means, and notifies the host computer used by the outputting person of the storage of the said storage folders for specified information; and
output means that reads and prints out the print job stored in the said storage means upon receipt of an instruction from the host computer used by the outputting person based on the storage folders for specified information.

3. A program for causing a computer equipped with a print job processing system that supplies an output device with print jobs stored in a host computer by the storing person in order to carry out the print jobs, comprising:
a process for independently registering various kinds of information outputted by a number of outputting persons in respective folders;
a process for generating print jobs and establishing storage folders for specified information that specifies the outputting person to the host computer used by the storing person;
a process for storing the print job associated with the storage folders for specified information in an external storage apparatus;
a process for storing the storage folders for specified information in folders corresponding to the predetermined outputting person, and notifying the predetermined outputting person of such storage; and
a process for of reading and printing out the print jobs stored in the external storage apparatus based on the storage folders for specified information determined by the host computer used by the outputting person.

4. A storage medium for storing the program according to claim 3.
